(19) United States
(12) Patent Application Publication
(10) Pub. No.: US 2005/0183754 A1
(43) Pub. Date: Aug. 25, 2005

(54) Apparatus for and method of cleaning substrate

(76) Inventors: Yoshikazu Kago, Kyoto (JP); Masaki Iwami, Kyoto (JP); Masahiro Nonomura, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/057,003

(22) Filed: Feb. 11, 2005

(30) Foreign Application Priority Data
Feb. 13, 2004 (JP) JP2004-036917

(51) Int. Cl. B08B 3/00

(52) U.S. Cl. 134/56 R; 134/137; 134/149; 134/157

(57) ABSTRACT

A substrate cleaning apparatus includes two cleaning brushes driven independently of each other. A first cleaning brush makes a cycling movement including an outward movement progressing in a horizontal direction from a position in contact with the center of the rotation of a substrate to the outside of an edge of the substrate, an upward movement progressing in a vertically upward direction from an end position of the outward movement, an inward movement progressing in a horizontal direction from an end position of the upward movement to a position immediately over the center of the rotation of the substrate, and a downward movement progressing in a vertically downward direction from an end position of the inward movement to a start position of the outward movement. A second cleaning brush makes a similar cycling movement. The first and second cleaning brushes are adapted so that the speed of the inward movement thereof is higher than that of the outward movement thereof and so that the speed of the upward movement is higher than that of the downward movement thereof.

### BACKGROUND OF THE INVENTION

1. Field of the Invention

The present invention relates to an apparatus for and a method of cleaning a substrate including a semiconductor substrate, a glass substrate for a liquid crystal display device, a glass substrate for a photomask, a substrate for an optical disk and the like by the use of, for example, a cleaning brush and the like while rotating the substrate.

2. Description of the Background Art

In general, the substrate is sequentially subjected to various processes including film deposition, resist coating, exposure, development, etching and the like for a series of photolithography processes. Contamination due to particles and the like deposited on the substrate during the above described processes results in significantly deteriorated characteristics of the substrate after the photolithography processes. For this reason, the substrate is cleaned using a substrate cleaning apparatus provided with various cleaning parts such as a cleaning brush, an ultrasonic cleaning nozzle, and a high-pressure cleaning nozzle.

Substrate cleaning apparatuses of this type which have often been used conventionally include a single-wafer type cleaning apparatus (known as a spin scrubber) provided with a cleaning brush brought in contact with or in proximity to an upper surface of a single substrate to be cleaned to mechanically remove contaminants such as particles while rotating the single substrate.

The single-wafer type cleaning apparatus has been required to increase in processing efficiency because of its low throughput as compared with a batch type apparatus despite its high accuracy for the cleaning process. To this end, a cleaning apparatus disclosed in, for example, Japanese Patent Application Laid-Open No. 10-308370 (1998) is adapted so that two cleaning brushes are attached to one support arm and are used to simultaneously clean a substrate. Another cleaning apparatus disclosed in, for example, Japanese Patent Application Laid-Open No. 10-4072 (1998) is adapted so that a plurality of arms each for holding a cleaning means such as a cleaning brush are provided and used to simultaneously clean a substrate.

In the recent semiconductor manufacturing field, however, there is a growing demand regarding process performance for substrate processing, and a demand for improvement in throughput becomes increasingly stringent. This creates a need for the increase in the number of cleaning units for parallel processing mounted in a single substrate cleaning apparatus, and a need for improving the processing efficiency itself of each of the cleaning units to reduce cleaning time.

### SUMMARY OF THE INVENTION

The present invention is intended for a substrate cleaning apparatus for performing a cleaning process while rotating a substrate.

According to the present invention, the substrate cleaning apparatus comprises: a rotation part for rotating a substrate in a substantially horizontal plane; a first cleaning part and a second cleaning part for cleaning a surface to be cleaned of the substrate rotated by the rotation part; a first driving part for causing the first cleaning part to make a cycling movement including an outward movement progressing in a substantially horizontal direction from the center of the rotation of the substrate toward an edge of the substrate while the first cleaning part cleans the surface of the substrate, an upward movement progressing in a substantially vertically upward direction from an end position of the outward movement, an inward movement progressing in a substantially horizontal direction from an end position of the upward movement toward the center of the rotation, and a downward movement progressing in a substantially vertically downward direction from an end position of the inward movement to a start position of the outward movement; a second driving part for causing the second cleaning part to make the cycling movement; and a drive control part for controlling the first driving part and the second driving part so that the speed of the inward movement of each of the first and second cleaning parts is higher than that of the outward movement thereof.

The substrate cleaning apparatus shortens the time required for the cycling movements of the first and second cleaning parts to improve cleaning efficiency, thereby reducing cleaning time.

Preferably, the drive control part controls the first driving part and the second driving part so that the speed of the upward movement of each of the first and second cleaning parts is higher than that of the downward movement thereof.

This further shortens the time required for the cycling movements of the first and second cleaning parts to improve cleaning efficiency, thereby further reducing the cleaning time.

The present invention is also intended for a method of cleaning a substrate while rotating the substrate.

It is therefore an object of the present invention to provide an apparatus for and a method of cleaning a substrate which are capable of increasing cleaning efficiency to reduce cleaning time.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view of a substrate processing apparatus with a substrate cleaning apparatus incorporated therein according to the present invention;

FIG. 2 is a front view showing the construction of a front surface scrubber of the substrate processing apparatus of FIG. 1;

FIG. 3 is a plan view showing the swing operation of cleaning brushes of the front surface scrubber of FIG. 2;

FIG. 4 is a conceptual diagram for illustrating the cleaning processing operation of the cleaning brushes of the front surface scrubber of FIG. 2;

FIG. 5 shows an example of an operation pattern of the two cleaning brushes; and

FIG. 6 shows another examples of the operation pattern of the two cleaning brushes.

### DESCRIPTION OF THE PREFERRED EMBODIMENTS

A preferred embodiment according to the present invention will now be described in detail with reference to the drawings.

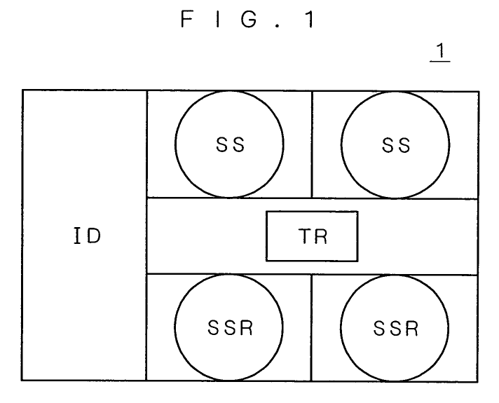

First, brief description will be give on a substrate processing apparatus 1 in which a spin scrubber that is an example of a substrate cleaning apparatus according to the present invention is incorporated. FIG. 1 is a schematic plan view of the substrate processing apparatus 1. This substrate processing apparatus 1 is an apparatus for performing a cleaning process on front and back surfaces of a substrate. The substrate processing apparatus 1 includes an indexer ID, two front surface scrubbers SS, two back surface scrubbers SSR, and a transport robot TR. The substrate processing apparatus 1 further includes a top-to-bottom inversion unit not shown for inverting or flipping the substrate from top to bottom or vice versa.

The indexer ID places thereon a cassette or carrier (not shown) which can accommodate a plurality of substrates, and includes a transfer robot. The indexer ID transfers an unprocessed substrate from the cassette to the transport robot TR, and receives a processed substrate from the transport robot TR to store the processed substrate in the cassette. The cassette may be of the following types: an OC (open cassette) which exposes the stored substrates to atmosphere; and a FOUP (front opening unified pod) and an SMIF (standard mechanical interface) pod which store substrates in an enclosed or sealed space.

Each of the front surface scrubbers SS performs a front surface cleaning process by applying a rinsing solution (deionized water) to a front surface (device surface) of a substrate and bringing a cleaning brush in contact with or in proximity to the front surface while rotating the substrate in a horizontal plane, with the front surface positioned upside. The front surface scrubbers SS employ a vacuum chuck for vacuum-holding a back surface (a surface opposite from the device surface) of the substrate under suction.

Each of the back surface scrubbers SSR performs a back surface cleaning process by applying a rinsing solution (deionized water) to the back surface of the substrate and bringing a cleaning brush in contact with or in proximity to the back surface while rotating the substrate in a horizontal plane, with the back surface positioned upside. The back surface scrubbers SSR are substantially similar in construction to the front surface scrubbers SS except that the back surface scrubbers SSR employ a mechanical chuck for mechanically holding an edge portion of the substrate because the front surface of the substrate cannot be vacuum-held under suction.

The transport robot TR includes a telescopically extendable and retractable mechanism, and two transport arms. The transport robot TR further includes a rotatable drive mechanism for rotatably driving the transport arms in a horizontal plane, and a forward and backward movement mechanism for moving the transport arms back and forth in the direction of a pivot radius. The transport robot TR is capable of moving the transport arms in three dimensions by the use of these mechanisms. The transport arms holding a substrate move in three dimensions to transfer the substrate to and from the front surface scrubbers SS, the back surface scrubbers SSR and the indexer ID, thereby allowing the substrate to be transported to these units and to be subjected to various processes.

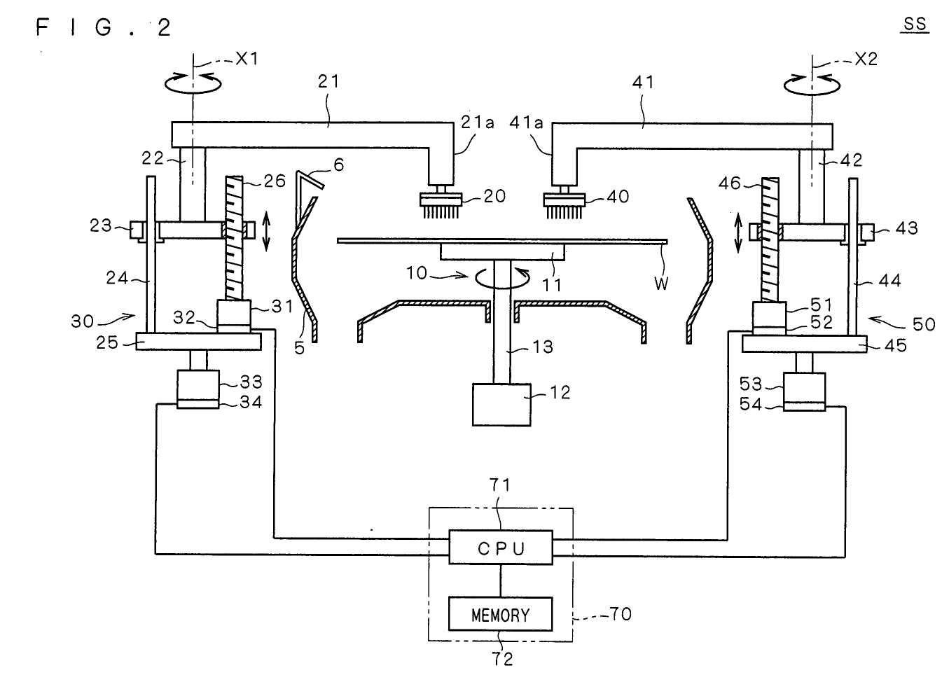

FIG. 2 is a front view showing the construction of each of the front surface scrubbers SS. The front surface scrubber SS shown in FIG. 2 includes a holding and rotating mechanism 10 for rotating a substrate W while holding the substrate W, a cup 5 for surrounding the substrate W during a cleaning process, two cleaning brushes 20 and 40 for cleaning a surface to be cleaned (an upper surface, or a front surface in the case of the front surface scrubber) of the substrate W, two drive mechanisms 30 and 50 for moving the cleaning brushes 20 and 40, respectively, independently of each other, and a controller 70 for controlling the drive mechanisms 30 and 50.

The holding and rotating mechanism 10 includes a spin chuck 11 and a rotary motor 12. A rotation shaft 13 for the rotary motor 12 is suspendedly provided on a central portion of the lower surface of the spin chuck 11. The spin chuck 11 includes a vacuum suction mechanism for vacuum-holding the back surface of the substrate W under suction to hold the substrate W in a horizontal plane. When the motor 12 rotates the rotation shaft 13 with the substrate W held by the spin chuck 11, the substrate W held by the spin chuck 11 also rotates about an axis parallel to a vertical direction in a horizontal plane.

The cup 5 surrounds the substrate W held by the spin chuck 11. The cup 5 is vertically movable by a lifting mechanism not shown. With the cup 5 in a lowered position, the spin chuck 11 is extended above the upper end of the cup 5. In this condition, the transport robot TR transfers and receives the substrate W to and from the spin chuck 11. With the cup 5 in a raised position, on the other hand, the cup 5 surrounds the substrate W held by the spin chuck 11, as shown in FIG. 2. In this condition, the cup 5 receives and collects the rinsing solution scattered by the rotation of the substrate W. Drain ports are provided in a lower portion of the cup 5 to drain the collected rinsing solution and an air flow supplied into the cup from the drain ports.

A rinsing solution nozzle 6 is provided on an upper end of a side portion of the cup 5. The rinsing solution nozzle 6 issues a jet of rinsing solution (deionized water) toward the to-be-cleaned surface of the substrate W held by the spin chuck 11. A high-pressure cleaning nozzle for issuing a jet of high-pressure rinsing solution and an ultrasonic cleaning nozzle for issuing a jet of rinsing solution subjected to ultrasound may be provided in addition to the rinsing solution nozzle 6.

The cleaning brushes 20 and 40 are mounted to the lower ends of pendent portions 21a and 41a on the distal ends of brush arms 21 and 41, respectively. Each of the cleaning brushes 20 and 40 includes a brush made of, for example, PVA (polyvinyl alcohol), nylon or the like, and the brush is brought into contact with or into close but predetermined spaced positional relation with the to-be-cleaned surface of the substrate W rotated by the rotary motor 12 to clean the to-be-cleaned surface. Motors may be contained in the pendent portions 21a and 41a of the brush arms 21 and 41, respectively, to rotate the cleaning brushes 20 and 40 themselves (known as a rotary and revolutionary brush).

The cleaning brush 20 is swingable in a horizontal plane and movable in a vertical direction by the drive mechanism 30 including a swing motor 33 and a vertical movement motor 31. Specifically, a proximal end portion of the brush arm 21 is fixedly coupled to a support shaft 22 mounted upright on a base plate 23. The base plate 23 is slidable relative to a guide bar 24 mounted upright on a rotary table 25, and is in threaded engagement with a ball screw 26 coupled to a motor shaft of the vertical movement motor 31. The vertical movement motor 31 for rotating the ball screw 26 is fixedly provided on the rotary table 25. Additionally, the rotary table 25 for fixing and holding the guide bar 24 and the vertical movement motor 31 is coupled to a motor shaft of the swing motor 33, and is rotated by the swing motor 33.

With this arrangement, when the swing motor 33 rotates the rotary table 25, the base plate 23 rotates and the brush arm 21 pivots. In response to this, the cleaning brush 20 swings in a horizontal plane about a swing axis X1 parallel to a vertical direction. When the vertical movement motor 31 rotates the ball screw 26 in a normal or reverse direction, the base plate 23 in threaded engagement with the ball screw 26 moves vertically. In response to this vertical movement, the brush arm 21 and the cleaning brush 20 also move in a vertical direction.

Similarly, the cleaning brush 40 is swingable in a horizontal plane and movable in a vertical direction by the drive mechanism 50 including a swing motor 53 and a vertical movement motor 51. Specifically, a proximal end portion of the brush arm 41 is fixedly coupled to a support shaft 42 mounted upright on a base plate 43. The base plate 43 is slidable relative to a guide bar 44 mounted upright on a rotary table 45, and is in threaded engagement with a ball screw 46 coupled to a motor shaft of the vertical movement motor 51. The vertical movement motor 51 for rotating the ball screw 46 is fixedly provided on the rotary table 45. Additionally, the rotary table 45 for fixing and holding the guide bar 44 and the vertical movement motor 51 is coupled to a motor shaft of the swing motor 53, and is rotated by the swing motor 53.

With this arrangement, when the swing motor 53 rotates the rotary table 45, the base plate 43 rotates and the brush arm 41 pivots. In response to this, the cleaning brush 40 swings in a horizontal plane about a swing axis X2 parallel to a vertical direction. When the vertical movement motor 51 rotates the ball screw 46 in a normal or reverse direction, the base plate 43 in threaded engagement with the ball screw 46 moves vertically. In response to this vertical movement, the brush arm 41 and the cleaning brush 40 also move in a vertical direction.

As described above, the cleaning brushes 20 and 40 are swingable in a horizontal plane and movable in a vertical direction by the drive mechanisms 30 and 50, respectively. For a cleaning processing operation to be described later, the cleaning brushes 20 and 40 make a vertical movement between a lowered position in contact with or in close but predetermined spaced positional relation with a substrate W and a raised position over the lowered position, and perform a swing operation between a position over the center of the rotation of the substrate W and a position over the outside of an edge of the substrate W. The cleaning processing operation of the cleaning brushes 20 and 40 will be described in further detail later. In addition to the cleaning processing operation, the drive mechanisms 30 and 50 can cause the cleaning brushes 20 and 40 to perform a retraction operation for moving to a retracted position outside the cup 5. This retraction operation is performed to prevent interference between the transport robot TR and the cleaning brushes 20 and 40 during the transport of a substrate W into and out of the front surface scrubber SS.

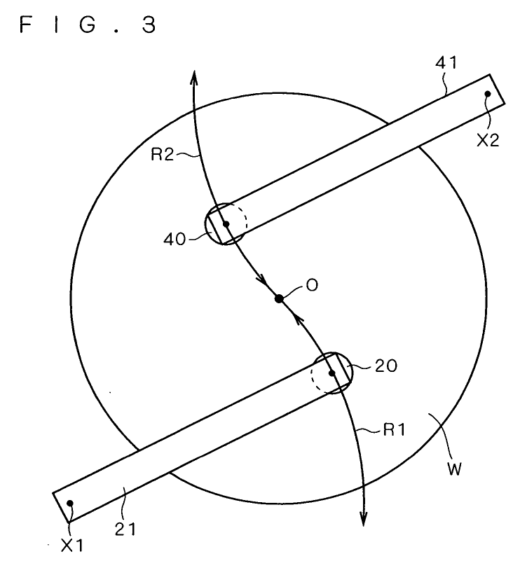

It is apparent from the above-mentioned construction that the vertical movement of the cleaning brushes 20 and 40 is a linear movement in a vertical direction whereas the swing operation thereof is not a linear movement but a horizontal movement along an arc. FIG. 3 is a plan view showing the swing operation of the cleaning brushes 20 and 40. The cleaning brush 20 is swung about a swing axis X1 in a horizontal direction along an arcuate path R1 passing through the center O of the rotation of the substrate W. Similarly, the cleaning brush 40 is swung about a swing axis X2 in a horizontal direction along an arcuate path R2 passing through the center O of the rotation of the substrate W. In other words, both of the cleaning brushes 20 and 40 can pass over the center O of the rotation of the substrate W by performing the swing operation.

The vertical movement motors 31 and 51 are provided with encoders 32 and 52, respectively. The encoders 32 and 52 are capable of detecting the speed of rotation, the amount of rotation and the direction of rotation of the vertical movement motors 31 and 51 to detect the speed of vertical movement, the vertical position and the direction of vertical movement of the cleaning brushes 20 and 40, respectively. Similarly, the swing motors 33 and 53 are provided with encoders 34 and 54, respectively. The encoders 34 and 54 are capable of detecting the speed of rotation, the amount of rotation and the direction of rotation of the swing motors 33 and 53 to detect the speed of swing movement, the swing position and the direction of swing movement of the cleaning brushes 20 and 40, respectively.

The vertical movement motors 31, 51 and the swing motors 33, 35 are all controlled by the controller 70. The controller 70 is similar in construction to a typical computer, and includes a CPU 71 for performing a computing process, a memory 72 for storing a predetermined processing program and data, a fixed disk not shown, an input/output interface not shown, and the like. The controller 70 controls the vertical movement motors 31, 51 and the swing motors 33, 53 in accordance with the processing program stored in the memory 72. Specifically, the controller 70 effects the feedback control of the vertical movement motors 31 and 51 based on detection signals from the encoders 32 and 52, respectively, and effects the feedback control of the swing motors 33 and 35 based on detection signals from the encoders 34 and 54, respectively, so that the vertical movement motors 31, 51 and the swing motors 33, 53 perform operations specified by the processing program.

For precise control of the operation of the cleaning brushes 20 and 40, it is desirable to employ pulse motors (stepping motors) capable of precisely controlling the speed and amount of rotation as the vertical movement motors 31, 51 and the swing motors 33, 53. Components whose operations can be precisely controlled may be used as the vertical movement motors 31, 51 and the swing motors 33, 53. For example, electromagnetic actuators and the like may be adopted in place of the motors.

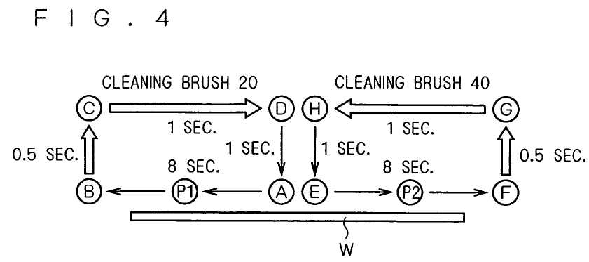

Next, the cleaning processing operation will be described. FIG. 4 is a conceptual diagram for illustrating the cleaning processing operation of the cleaning brushes 20 and 40. The cleaning brush 20 is driven by the drive mechanism 30 to make a cycling movement including the following four movements: an outward movement progressing in a horizontal direction from a position A in which the cleaning brush 20 is in contact with (or in proximity to) the center O of the rotation of the substrate W to the outside of an edge of the substrate W while the cleaning brush 20 cleans the to-be-cleaned surface of the substrate W; an upward movement progressing in a vertically upward direction from an end position B of the outward movement; an inward movement progressing in a horizontal direction from an end position C of the upward movement to a position D immediately over the center O of the rotation; and a downward movement progressing in a vertically downward direction from the end position D of the inward movement to the start position A of the outward movement. That is, the cleaning brush 20 performs a cleaning operation for sweeping away contaminants from the center O of the rotation of the substrate W toward the edge thereof by making the outward movement. After the completion of the outward movement, the cleaning brush 20 makes the upward movement, the inward movement, and the downward movement to return to the starting point of the cleaning operation. Such a cycling operation is accomplished by the controller 70 controlling the swing motor 33 and the vertical movement motor 31.

In this preferred embodiment, the time required for the cleaning brush 20 to make the outward movement from the position A to the position B is eight seconds, the time required to make the upward movement from the position B to the position C is 0.5 second, the time required to make the inward movement from the position C to the position D is one second, and the time required to make the downward movement from the position D to the position A is one second. Thus, the controller 70 controls the swing motor 33 so that the speed of the inward movement of the cleaning brush 20 is higher than that of the outward movement thereof. Also, the controller 70 controls the vertical movement motor 31 so that the speed of the upward movement of the cleaning brush 20 is higher than that of the downward movement thereof. Additionally, when the cleaning brush 20 passes through a midpoint position P1 between the position A and the position B in the course of the outward movement, the encoder 34 detects the passage to transmit a passage detection signal to the controller 70.

Similarly, the cleaning brush 40 is driven by the drive mechanism 50 to make a cycling movement including the following four movements: an outward movement progressing in a horizontal direction from a position E in which the cleaning brush 40 is in contact with (or in proximity to) the center O of the rotation of the substrate W to the outside of an edge of the substrate W while the cleaning brush 40 cleans the to-be-cleaned surface of the substrate W; an upward movement progressing in a vertically upward direction from an end position F of the outward movement; an inward movement progressing in a horizontal direction from an end position G of the upward movement to a position H immediately over the center O of the rotation; and a downward movement progressing in a vertically downward direction from the end position H of the inward movement to the start position E of the outward movement. That is, the cleaning brush 40 performs a cleaning operation for sweeping away contaminants from the center O of the rotation of the substrate W toward the edge thereof by making the outward movement. After the completion of the outward movement, the cleaning brush 40 makes the upward movement, the inward movement, and the downward movement to return to the starting point of the cleaning operation. Such a cycling operation is accomplished by the controller 70 controlling the swing motor 53 and the vertical movement motor 51.

In this preferred embodiment, the time required for the cleaning brush 40 to make the outward movement from the position E to the position F is eight seconds, the time required to make the upward movement from the position F to the position G is 0.5 second, the time required to make the inward movement from the position G to the position H is one second, and the time required to make the downward movement from the position H to the position E is one second. Thus, the controller 70 controls the swing motor 53 so that the speed of the inward movement of the cleaning brush 40 is higher than that of the outward movement thereof. Also, the controller 70 controls the vertical movement motor 51 so that the speed of the upward movement of the cleaning brush 40 is higher than that of the downward movement thereof. Additionally, when the cleaning brush 40 passes through a midpoint position P2 between the position E and the position F in the course of the outward movement, the encoder 54 detects the passage to transmit a passage detection signal to the controller 70.

Thus, the cleaning brushes 20 and 40 each make the cycling movement which requires 10.5 seconds for one cycle, and are identical in operation pattern with each other. For both of the cleaning brushes 20 and 40, the inward movement is faster than the outward movement, and the upward movement is faster than the downward movement. The outward movement is an important operation such that the cleaning brushes 20 and 40 come in contact with or in proximity to the to-be-cleaned surface of the substrate W to clean the to-be-cleaned surface, and a considerable amount of time is required for reliable cleaning. The inward movement, on the other hand, is an operation such that the cleaning brushes 20 and 40 simply move back to the position immediately over the center O of the rotation of the substrate W, and preferably takes as little time as possible. For these reasons, the inward movement of the cleaning brushes 20 and 40 is made faster than the outward movement thereof.

The downward movement is an operation such that the cleaning brushes 20 and 40 are brought into contact with or into proximity to the center O of the rotation of the substrate W, and there is a danger that the cleaning brushes 20 and 40 give an impact to the substrate W if the downward movement is too fast. During the upward movement, on the other hand, there is no danger that the cleaning brushes 20 and 40 give an impact to the substrate W. Preferably, the upward movement takes as little time as possible. For these reasons, the upward movement of the cleaning brushes 20 and 40 is made faster than the downward movement thereof.

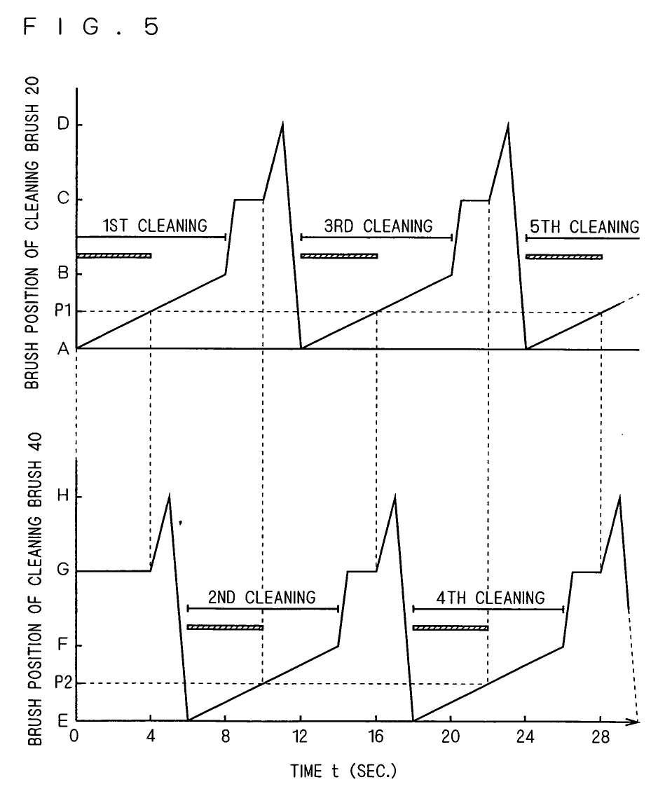

In the front surface scrubber SS of this preferred embodiment, it is necessary to prevent the cleaning brushes 20 and 40 from interfering with each other because both of the cleaning brushes 20 and 40 pass over the center O of the rotation of the substrate W. To this end, the front surface scrubber SS of this preferred embodiment is adapted to effect the cycling movements of the cleaning brushes 20 and 40 in a manner to be described below during the actual cleaning process. FIG. 5 is an example of the operation pattern of the cleaning brushes 20 and 40. In FIG. 5, the ordinate represents the brush position of the cleaning brushes 20 and 40, and the abscissa represents time t elapsed since the start of the cleaning processing operation.

First, each of the cleaning brushes 20 and 40 is retracted to the retracted position outside the cup 5, and the transport robot TR transports a substrate W to be processed into the front surface scrubber SS, with the cup 5 in its lowered position, to transfer the substrate W with the front surface positioned upside to the spin chuck 11. The spin chuck 11 vacuum-holds the back surface of the substrate W under suction. Subsequently, the cup 5 moves upwardly to the side of the substrate W, and the rotation of the substrate W by the rotary motor 12 and the application of the deionized water from the rinsing solution nozzle 6 to the surface of the substrate W are started. Thereafter, each of the cleaning brushes 20 and 40 moves to a position in which the cycling movement starts. At this time, the cleaning brush 20 moves to the position A in contact with or in proximity to the center O of the rotation of the substrate W, and the cleaning brush 40 moves to the raised position G outside the edge of the substrate W.

Next, the cleaning processing operation is initiated in accordance with an instruction from the controller 70. The cleaning brush 20 starts the outward movement at time t=0 sec. This executes the first cleaning of the substrate W. In this step, if the cleaning brush 40 immediately starts the high-speed inward movement simultaneously with the start of the outward movement of the cleaning brush 20, there is a danger that interference occurs between the cleaning brush 20 and the cleaning brush 40 because the cleaning brush 20 is in the vicinity of the center O of the rotation. To prevent this, the controller 70 causes the cleaning brush 40 to remain stopped in the position G until the encoder 34 detects the passage of the cleaning brush 20 through the position P1.

Thereafter, the cleaning brush 20 passes through the midpoint position P1 between the position A and the position B at time t=4 sec. Upon detection of the passage of the cleaning brush 20 through the position P1 during the outward movement of the cleaning brush 20, the encoder 34 transmits the passage detection signal to the controller 70. At the instant when the controller 70 receives the passage detection signal, the controller 70 starts the inward movement of the cleaning brush 40.

Because the inward movement is completed in one second, the cleaning brush 40 reaches the position H immediately over the center O of the rotation at time t=5 sec. At this time, the interference does not occur between the cleaning brush 20 and the cleaning brush 40 because more than half of the outward movement of the cleaning brush 20 is completed and the cleaning brush 20 is already remote from the vicinity of the center O of the rotation although in the course of the outward movement.

Next, the cleaning brush 40 makes the downward movement, and reaches the position E in contact with or in proximity to the center O of the rotation of the substrate W at time t=6 sec. The cleaning brush 40 also starts the outward movement. This executes the second cleaning of the substrate W. Thereafter, the outward movement of the cleaning brush 20 is completed at time t=8 sec., and the cleaning brush 20 reaches the position B. Thus, the cleaning brush 20 and the cleaning brush 40 simultaneously perform the cleaning process for two seconds between time t=6 sec. and time t=8 sec. At the instant when the cleaning brush 40 starts the outward movement, the simultaneous execution of the cleaning process of the cleaning brush 20 and the cleaning brush 40 does not cause the interference between the cleaning brush 20 and the cleaning brush 40 because the cleaning brush 20 is already remote from the vicinity of the center O of the rotation.

Subsequently, the cleaning brush 40 continues the outward movement, and the cleaning brush 20 makes the upward movement. Thereafter, the cleaning brush 20 reaches the position C at time t=8.5 sec. At this time, the cleaning brush 40 is in the course of the outward movement and yet is performing the cleaning process in the vicinity of the center O of the rotation of the substrate W. Thus, there is a danger that the interference occurs between the cleaning brush 20 and the cleaning brush 40 if the cleaning brush 20 immediately makes the high-speed inward movement. To prevent this, the controller 70 causes the cleaning brush 20 to remain stopped in the position C until the encoder 54 detects the passage of the cleaning brush 40 through the position P2.

Thereafter, the cleaning brush 40 passes through the midpoint position P2 between the position E and the position F at time t=10 sec. Upon detection of the passage of the cleaning brush 40 through the position P2 during the outward movement of the cleaning brush 40, the encoder 54 transmits the passage detection signal to the controller 70. At the instant when the controller 70 receives the passage detection signal, the controller 70 starts the inward movement of the cleaning brush 20.

Next, the cleaning brush 20 reaches the position D immediately over the center O of the rotation at time t=11 sec. At this time, the interference does not occur between the cleaning brush 20 and the cleaning brush 40 because more than half of the outward movement of the cleaning brush 40 is completed and the cleaning brush 40 is already remote from the vicinity of the center O of the rotation although in the course of the outward movement.

Next, the cleaning brush 20 makes the downward movement, and reaches the position A which is the starting point of the outward movement thereof at time t=12 sec. The cleaning brush 20 starts the outward movement. This executes the third cleaning of the substrate W. Thereafter, the outward movement of the cleaning brush 40 is completed at time t=14 sec., and the cleaning brush 40 reaches the position F. Thus, the cleaning brush 20 and the cleaning brush 40 simultaneously perform the cleaning process for two seconds between time t=12 sec. and time t=14 sec. At the instant when the cleaning brush 20 starts the outward movement, the simultaneous execution of the cleaning process of the cleaning brush 20 and the cleaning brush 40 does not cause the interference between the cleaning brush 20 and the cleaning brush 40 because the cleaning brush 40 is already remote from the vicinity of the center O of the rotation.

Subsequently, the cleaning brush 20 continues the outward movement, and the cleaning brush 40 makes the upward movement. Thereafter, the cleaning brush 40 reaches the position G at time t=14.5 sec. At this time, the cleaning brush 20 is in the course of the outward movement and yet is performing the cleaning process in the vicinity of the center O of the rotation of the substrate W. Thus, there is a danger that the interference occurs between the cleaning brush 20 and the cleaning brush 40 if the cleaning brush 40 immediately makes the high-speed inward movement. To prevent this, the controller 70 causes the cleaning brush 40 to remain stopped in the position G until the encoder 34 detects the passage of the cleaning brush 20 through the position P1.

Thereafter, a procedure similar to the above is repeated for execution of the cleaning process using the cleaning brush 20 and the cleaning brush 40 in an alternating manner. After the cleaning process is executed a predetermined number of times, each of the cleaning brushes 20 and 40 is retracted to the retracted position outside the cup 5. At the same time, the rotation of the substrate W and the application of the deionized water from the rinsing solution nozzle 6 are stopped, and the cup 5 is moved downwardly. Then, the transport robot TR receives the substrate W subjected to the cleaning process from the spin chuck 11, and exits the front surface scrubber SS.

The operation pattern as in this preferred embodiment requires eight seconds for the completion of one cleaning process (or one outward movement) using the cleaning brushes 20 and 40 after the start of the cleaning processing operation, 14 seconds for the completion of two cleaning processes, 20 seconds for the completion of three cleaning processes, and 62 seconds for the completion of ten cleaning processes. If only one of the cleaning brush 20 and the cleaning brush 40 is used for the cleaning processing operation, it takes eight seconds for the completion of one cleaning process, 18.5 seconds for the completion of two cleaning processes, 29 seconds for the completion of three cleaning processes, and 102.5 seconds for the completion of ten cleaning processes. If the outward and inward movements of the cleaning brushes 20 and 40 are made at the same speed and the upward and downward movements thereof are made at the same speed as in a conventional operation, it takes eight seconds for the completion of one cleaning process, 17 seconds for the completion of two cleaning processes, 26 seconds for the completion of three cleaning processes, and 89 seconds for the completion of ten cleaning processes.

As described above, this preferred embodiment is adapted so that the speed of the inward movement of each of the cleaning brushes 20 and 40 is higher than that of the outward movement thereof and so that the speed of the upward movement of each of the cleaning brushes 20 and 40 is higher than that of the downward movement thereof. This increases the efficiency of the cleaning processing using the cleaning brushes 20 and 40 to reduce cleaning time.

Further, during the outward movement of the cleaning brush 20, the start of the inward movement of the cleaning brush 40 is stopped until the encoder 34 detects the passage of the cleaning brush 20 through the midpoint position P1, and is started at the instant when the encoder 34 detects the passage of the cleaning brush 20 through the midpoint position P1. During the outward movement of the cleaning brush 40, the start of the inward movement of the cleaning brush 20 is stopped until the encoder 54 detects the passage of the cleaning brush 40 through the midpoint position P2, and is started at the instant when the encoder 54 detects the passage of the cleaning brush 40 through the midpoint position P2. This reliably prevents the cleaning brushes 20 and 40 from interfering with each other in the vicinity of the center O of the rotation of the substrate W.

A time period represented by each shaded bar in FIG. 5 is a time period during which the cleaning brush 20 or the cleaning brush 40 is in the vicinity of the center O of the rotation of the substrate W. Because the inward movement of one of the cleaning brushes is held in a waiting state until the other cleaning brush passes through the midpoint position of the outward movement, the cleaning brushes 20 and 40 are prevented from being positioned at the same time in the vicinity of the center O of the rotation of the substrate W, as shown in FIG. 5.

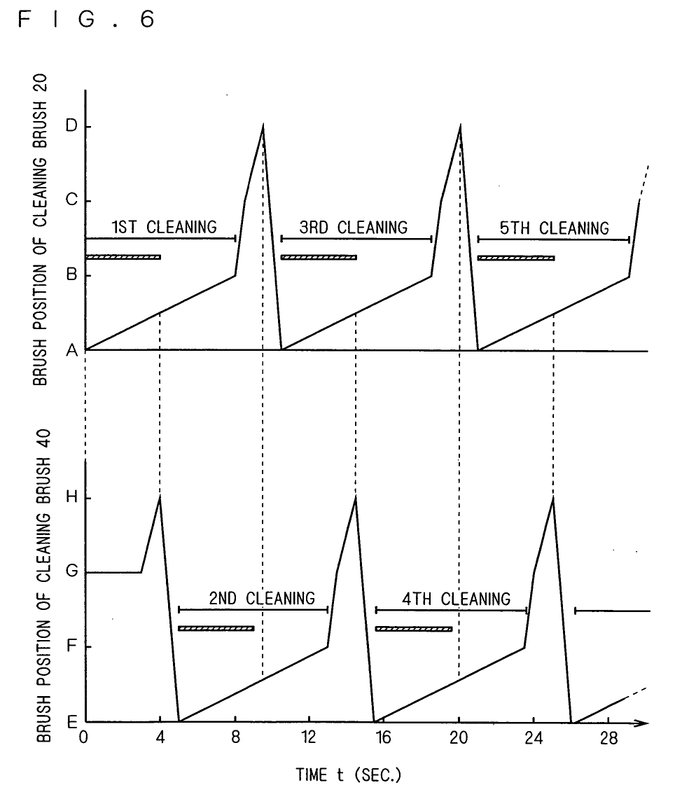

The preferred embodiment according to the present invention has been described hereinabove, the present invention is not limited to the above-mentioned example. The above-mentioned preferred embodiment employs the encoders 34 and 54 to detect the passage of the cleaning brushes 20 and 40 through the midpoint positions P1 and P2, and holds the inward movement of one of the cleaning brushes in the waiting state until the other cleaning brush passes through the midpoint position of the outward movement thereof, thereby preventing the cleaning brushes 20 and 40 from interfering with each other. Alternatively, the cleaning brushes 20 and 40 may be operated, for example, in an operation pattern as shown in FIG. 6. Also in FIG. 6, the ordinate represents the brush position of the cleaning brushes 20 and 40, and the abscissa represents time t elapsed since the start of the cleaning processing operation.

As in the above-mentioned preferred embodiment, after a substrate W is transported into the front surface scrubber SS, the cleaning brush 20 moves to the position A in contact with or in proximity to the center O of the rotation of the substrate W, and the cleaning brush 40 moves to the raised position G outside an edge of the substrate W. In the operation pattern shown in FIG. 6, the cleaning brush 20 starts the outward movement at time t=0 sec., and thereafter the cleaning brush 40 starts the inward movement at time t=3 sec. In this step, the first cleaning of the substrate W is executed by the cleaning brush 20. Thereafter, at time t=4 sec., the cleaning brush 40 reaches the position H immediately over the center O of the rotation, and the cleaning brush 20 reaches the midpoint position P1 of the outward movement thereof. At this time, the interference does not occur between the cleaning brush 20 and the cleaning brush 40 because half of the outward movement of the cleaning brush 20 is completed and the cleaning brush 20 is already remote from the vicinity of the center O of the rotation although in the course of the outward movement.

Next, the cleaning brush 40 makes the downward movement, and reaches the position E in contact with or in proximity to the center O of the rotation of the substrate W at time t=5 sec. The cleaning brush 40 also starts the outward movement. This executes the second cleaning of the substrate W. Thereafter, the outward movement of the cleaning brush 20 is completed at time t=8 sec., and the cleaning brush 20 reaches the position B. Thus, the cleaning brush 20 and the cleaning brush 40 simultaneously perform the cleaning process for three seconds between time t=5 sec. and time t=8 sec. At the instant when the cleaning brush 40 starts the outward movement, the simultaneous execution of the cleaning process of the cleaning brush 20 and the cleaning brush 40 does not cause the interference between the cleaning brush 20 and the cleaning brush 40 because the cleaning brush 20 is already remote from the vicinity of the center O of the rotation.

Subsequently, the cleaning brush 40 continues the outward movement, and the cleaning brush 20 makes the upward movement. Thereafter, the cleaning brush 20 reaches the position C at time t=8.5 sec. In the pattern shown in FIG. 6, the cleaning brush 20 starts the inward movement, upon reaching the position C. Thus, the cleaning brush 20 reaches the position D immediately over the center O of the rotation at time t=9.5 sec. At this time, the interference does not occur between the cleaning brush 20 and the cleaning brush 40 because more than half of the outward movement of the cleaning brush 40 is completed and the cleaning brush 40 is already remote from the vicinity of the center O of the rotation although in the course of the outward movement.

Next, the cleaning brush 20 makes the downward movement, and reaches the position A which is the starting point of the outward movement thereof at time t=10.5 sec. The cleaning brush 20 starts the outward movement again. This executes the third cleaning of the substrate W. Thereafter, the outward movement of the cleaning brush 40 is completed at time t=13 sec., and the cleaning brush 40 reaches the position F. Thus, the cleaning brush 20 and the cleaning brush 40 simultaneously perform the cleaning process for 2.5 seconds between time t=10.5 sec. and time t=13 sec. At the instant when the cleaning brush 20 starts the second outward movement, the simultaneous execution of the cleaning process of the cleaning brush 20 and the cleaning brush 40 does not cause the interference between the cleaning brush 20 and the cleaning brush 40 because the cleaning brush 40 is already remote from the vicinity of the center O of the rotation.

Subsequently, the cleaning brush 20 continues the outward movement, and the cleaning brush 40 makes the upward movement. Thereafter, the cleaning brush 40 reaches the position G at time t=13.5 sec. In the pattern shown in FIG. 6, the cleaning brush 40 starts the inward movement, upon reaching the position G. Thus, the cleaning brush 40 reaches the position H immediately over the center O of the rotation at time t=14.5 sec. At this time, the interference does not occur between the cleaning brush 20 and the cleaning brush 40 because half of the outward movement of the cleaning brush 20 is completed and the cleaning brush 20 is already remote from the vicinity of the center O of the rotation although in the course of the outward movement.

Thereafter, a procedure similar to the above is repeated for execution of the cleaning process using the cleaning brush 20 and the cleaning brush 40 in an alternating manner. Operating the cleaning brushes 20 and 40 in accordance with the pattern shown in FIG. 6 requires eight seconds for the completion of one cleaning process, 13 seconds for the completion of two cleaning processes, 18.5 seconds for the completion of three cleaning processes, and 55 seconds for the completion of ten cleaning processes.

As described above, the pattern shown in FIG. 6 is also adapted so that the speed of the inward movement of each of the cleaning brushes 20 and 40 is higher than that of the outward movement thereof and so that the speed of the upward movement of each of the cleaning brushes 20 and 40 is higher than that of the downward movement thereof. This increases the efficiency of the cleaning processing using the cleaning brushes 20 and 40 to reduce the cleaning time.

The detection of the passage of the cleaning brushes 20 and 40 through the midpoint positions P1 and P2 by the use of the encoders 34 and 54 is not particularly performed in the pattern shown in FIG. 6. However, the interference between the cleaning brushes 20 and 40 is prevented in the pattern shown in FIG. 6 by staggering the starting times of the cycling movements of the respective cleaning brushes 20 and 40. Because the cycling movements of the cleaning brushes 20 and 40 are completely identical in period and in operation pattern with each other, the cleaning brushes 20 and 40 are reliably prevented from interfering with each other in the vicinity of the center O of the rotation of the substrate W by staggering the starting times of the cycling movements of the respective cleaning brushes 20 and 40 so as to prevent the cleaning brushes 20 and 40 from being positioned at the same time in the vicinity of the center O of the rotation of the substrate W.

A time period represented by each shaded bar in FIG. 6 is a time period during which the cleaning brush 20 or the cleaning brush 40 is in the vicinity of the center O of the rotation of the substrate W. In the pattern shown in FIG. 6, the starting times of the cycling movements of the respective cleaning brushes 20 and 40 are staggered so that no overlap occurs between the time periods represented by the shaded bars.

The pattern shown in FIG. 6 can achieve shorter processing time than the above-mentioned preferred embodiment because of the absence of the time intervals during which the cleaning brushes 20 and 40 stop. It is, however, preferable to control the operations of the cleaning brushes 20 and 40 based on the detection from the encoders 34 and 54 for the purpose of reliably preventing the interference between the cleaning brushes 20 and 40. In particular, the operation as in the above-mentioned preferred embodiment is required if any difference exists in period and in operation pattern between the cycling movements of the respective cleaning brushes 20 and 40.

The position where the passage of one of the cleaning brushes triggers the start of the inward movement of the other cleaning brush is the midpoint position of the outward movement in the above-mentioned preferred embodiment. The triggering position, however, is not limited to the midpoint position of the outward movement, but may be a position which reliably prevents the cleaning brushes 20 and 40 from being positioned at the same time in the vicinity of the center O of the rotation of the substrate W. Bringing the triggering position toward the center O of the rotation decreases the period of the cycling movements of the cleaning brushes to reduce the cleaning time, but increases the danger of the interference between the cleaning brushes.

The components for detecting the passage of the cleaning brushes 20 and 40 through the midpoint positions P1 and P2 are not limited to the encoders 34 and 54. For example, optical sensors may be provided to detect the passage of the cleaning brushes 20 and 40.

The time required for the cycling movements of the cleaning brushes 20 and 40 is not limited to the above-mentioned example. The outward movement is required only to be made at a speed suitable for reliable removal of contaminants, and the downward movement is required only to be made at a speed such that the cleaning brushes 20 and 40 give no impact to the substrate W. The upward movement and the inward movement may be made at the maximum speed of the cleaning brushes 20 and 40.

Each of the cleaning brushes 20 and 40 may be moved so that the speed of the upward movement and the speed of the downward movement are equal to each other and so that only the speed of the inward movement is higher than the speed of the outward movement. Alternatively, each of the cleaning brushes 20 and 40 may be moved so that the speed of the inward movement and the speed of the outward movement are equal to each other and so that only the speed of the upward movement is higher than the speed of the downward movement.

The number of cleaning brushes is not limited to two, but may be at least one. Regardless of the number of cleaning brushes, the cleaning time can be reduced by making the speed of the inward movement higher than that of the outward movement and making the speed of the upward movement higher than that of the downward movement.

The cleaning brushes in the back surface scrubbers SSR may be driven in the above-mentioned manner.

The cleaning part driven in the operation pattern as described above is not limited to the cleaning brush, but may be, for example, a high-pressure cleaning nozzle and an ultrasonic cleaning nozzle.

The substrate to be processed in the substrate cleaning apparatus according to the present invention is not limited to a semiconductor wafer, but may be a glass substrate for a liquid crystal display device and the like.

While the invention has been described in detail, the foregoing description is in all aspects illustrative and not restrictive. It is understood that numerous other modifications and variations can be devised without departing from the scope of the invention.

1. A substrate cleaning apparatus for performing a cleaning process while rotating a substrate, comprising:
a rotation part for rotating a substrate in a substantially horizontal plane;
a first cleaning part and a second cleaning part for cleaning a surface to be cleaned of the substrate rotated by said rotation part;
a first driving part for causing said first cleaning part to make a cycling movement including an outward movement progressing in a substantially horizontal direction from the center of the rotation of the substrate toward an edge of the substrate while said first cleaning part cleans said surface of the substrate, an upward movement progressing in a substantially vertically upward direction from an end position of said outward movement, an inward movement progressing in a substantially horizontal direction from an end position of said upward movement toward said center of the rotation, and a downward movement progressing in a substantially vertically downward direction from an end position of said inward movement to a start position of said outward movement;
a second driving part for causing said second cleaning part to make said cycling movement; and
a drive control part for controlling said first driving part and said second driving part so that the speed of said inward movement of each of said first and second cleaning parts is higher than that of said outward movement thereof.

2. The substrate cleaning apparatus according to claim 1, wherein said drive control part controls said first driving part and said second driving part so that the speed of said upward movement of each of said first and second cleaning parts is higher than that of said downward movement thereof.

3. The substrate cleaning apparatus according to claim 2, wherein
said drive control part makes said cycling movements of said first and second cleaning parts identical in operation pattern with each other, and staggers the times of said cycling movements of said first and second cleaning parts to prevent said first and second cleaning parts from interfering with each other.

4. The substrate cleaning apparatus according to claim 2, further comprising:
a first detection part for detecting the passage of said first cleaning part through a first predetermined position during said outward movement thereof; and
a second detection part for detecting the passage of said second cleaning part through a second predetermined position during said outward movement thereof,
wherein said drive control part controls said first driving part and said second driving part to cause said second cleaning part to start said inward movement at the instant when said first detection part detects the passage of said first cleaning part through said first predetermined position during said outward movement of said first cleaning part, and to cause said first cleaning part to start said inward movement at the instant when said second detection part detects the passage of said second cleaning part through said second predetermined position during said outward movement of said second cleaning part.

5. The substrate cleaning apparatus according to claim 4, wherein
said first and second predetermined positions are midpoint positions of paths of said outward movements of said first and second cleaning parts, respectively.

6. The substrate cleaning apparatus according to claim 1, wherein
each of said first and second cleaning parts is a cleaning brush coming in contact with or in proximity to said surface of the substrate for cleaning said surface during said outward movement.

7. A substrate cleaning apparatus for performing a cleaning process while rotating a substrate, comprising:
a rotation part for rotating a substrate in a substantially horizontal plane;
a plurality of cleaning parts for cleaning a surface to be cleaned of the substrate rotated by said rotation part;
a driving part for causing each of said plurality of cleaning parts to make an outward movement progressing in a substantially horizontal direction from the center of the rotation of the substrate toward an edge of the substrate while each of said plurality of cleaning parts cleans said surface of the substrate, and an inward movement progressing in a substantially horizontal direction from the edge of said substrate toward said center of the rotation; and
a drive control part for controlling said driving part so that the speed of said inward movement of each of said plurality of cleaning parts is higher than that of said outward movement thereof.

8. The substrate cleaning apparatus according to claim 7, wherein
said driving part further causes each of said plurality of cleaning parts to make an upward movement progressing in a substantially vertically upward direction from an end position of said outward movement to a start position of said inward movement, and a downward movement progressing in a substantially vertically downward direction from an end position of said inward movement to a start position of said outward movement, and
said drive control part controls said driving part so that the speed of said upward movement of each of said plurality of cleaning parts is higher than that of said downward movement thereof.

9. A substrate cleaning apparatus for performing a cleaning process while rotating a substrate, comprising:
a rotation part for rotating a substrate in a substantially horizontal plane;
a cleaning part for cleaning a surface to be cleaned of the substrate rotated by said rotation part;
a driving part for causing said cleaning part to make an outward movement progressing in a substantially horizontal direction from the center of the rotation of the substrate toward an edge of the substrate while said cleaning part cleans said surface of the substrate, and an inward movement progressing in a substantially horizontal direction from the edge of said substrate toward said center of the rotation; and
a drive control part for controlling said driving part so that the speed of said inward movement of said cleaning part is higher than that of said outward movement thereof.

10. The substrate cleaning apparatus according to claim 9, wherein
said driving part further causes said cleaning part to make an upward movement progressing in a substantially vertically upward direction from an end position of said outward movement to a start position of said inward movement, and a downward movement progressing in a substantially vertically downward direction from an end position of said inward movement to a start position of said outward movement, and
said drive control part controls said driving part so that the speed of said upward movement of said cleaning part is higher than that of said downward movement thereof.

11. A method of cleaning a substrate while rotating the substrate, comprising the steps of:
rotating a substrate in a substantially horizontal plane;
causing a first cleaning part to make a cycling movement including an outward movement progressing in a substantially horizontal direction from the center of the rotation of the substrate toward an edge of the substrate while said first cleaning part cleans a surface to be cleaned of the substrate, an upward movement progressing in a substantially vertically upward direction from an end position of said outward movement, an inward movement progressing in a substantially horizontal direction from an end position of said upward movement toward said center of the rotation, and a downward movement progressing in a substantially vertically downward direction from an end position of said inward movement to a start position of said outward movement; and
causing a second cleaning part to make said cycling movement,
wherein the speed of said inward movement of each of said first and second cleaning parts is higher than that of said outward movement thereof.

12. The method according to claim 11, wherein
the speed of said upward movement of each of said first and second cleaning parts is higher than that of said downward movement thereof.

13. The method according to claim 12, wherein
said cycling movements of said first and second cleaning parts are made identical in operation pattern with each other, and the times of said cycling movements of said first and second cleaning parts are staggered so that said first and second cleaning parts are prevented from interfering with each other.

14. The method according to claim 12, wherein
said second cleaning part starts said inward movement at the instant when said first cleaning part passes through a first predetermined position during said outward movement of said first cleaning part, and said first cleaning part starts said inward movement at the instant when said second cleaning part passes through a second predetermined position during said outward movement of said second cleaning part.
